(19) United States
(12) Patent Application Publication
(10) Pub. No.: US 2026/0353358 A1
(43) Pub. Date: Nov. 5, 2026

(54) LOW POWER WAKE-UP SIGNAL BEACON OR LOW POWER SYNCHRONIZATION SIGNAL FOR EMERGENCY OR COMMON PURPOSE PAGING

(71) Applicant: Nokia Technologies Oy, Espoo (FI)

(72) Inventors: Brajesh SONI, Bangalore (IN); Tanumay MANNA, Bangalore (IN); Knud; KNUDSEN, Aalborg (DK); Jan Torst HVIID, Aalborg (DK); David BHATOOLAUL, Swindon Wiltshire (GB); SunYoung LEE, Seoul (KR); Alok SETHI, Oulu (FI)

(73) Assignee: Nokia Technologies Oy, Espoo (FI)

(21) Appl. No.: 19/485,069

(22) PCT Filed: May 18, 2024
(86) PCT No.: PCT/IB2024/054851

§ 371 Date: Nov. 17, 2025

(30) Foreign Application Priority Data
May 19, 2023 (IN) 202341035132

(51) Int. Cl. H04W 68/02; H04L 27/04; H04W 52/02

(52) U.S. Cl. CPC H04W 68/02; H04L 27/04; H04W 52/0235

(57) ABSTRACT

In accordance with example embodiments of the invention there is at least a method an apparatus to perform receiving or determining at least one of a beacon, synchronization signal, or reference signal comprising an indication of a paging occurrence, wherein the at least one of a beacon, synchronization signal, or reference signal comprises a pseudo noise sequence as an indication of the paging occurrence, wherein the at least one of a beacon, synchronization signal, or reference signal is addressed to all user equipment of a group or sub-group of user equipment in at least one cell of the communication network, and wherein the at least one of a beacon, synchronization signal, or reference signal comprises a paging arrival for a common cause, and wherein at least one user equipment of the group or sub-group of user equipment is in one of a sleep mode or powered off; and wherein based on the at least one of a beacon, synchronization signal, or reference signal, there is waking from the sleep mode or powering on to decode the at least one of a beacon, synchronization signal, or reference signal and receive the paging occurrence.

### TECHNICAL FIELD

The teachings in accordance with the exemplary embodiments of this invention relate generally to a new method where a network can send an indication of paging arrival to all or maximum number of user equipment and, more specifically, relate to a new method where a network can send an indication of paging arrival to all or maximum number of user equipment in a single low power wake up signal (LP-WUS) occasion in case of common paging cause such as but not limited to an emergency page message.

### BACKGROUND

This section is intended to provide a background or context to the invention that is recited in the claims. The description herein may include concepts that could be pursued, but are not necessarily ones that have been previously conceived or pursued. Therefore, unless otherwise indicated herein, what is described in this section is not prior art to the description and claims in this application and is not admitted to be prior art by inclusion in this section.

Certain abbreviations that may be found in the description and/or in the Figures are herewith defined as follows:

| | |
|---|---|
| FSK | frequency shift keying |
| LR | low power Radio |
| LP-Beacon | low power beacon |
| LP-SS | low power synchronization signal |
| LP-WUS | low power wake up signal |
| MR | main radio |
| NW | network |
| OOK | on-off keying |
| RAN | random access network |
| RRC | radio resource control |
| UE | user Equipment |
| WUS | wake Up Signal |

Some standards at the time of this application are based on studies to evaluate L1 procedures and higher layer protocol changes needed to support the wake-up signals [RAN2, RAN1].

These studies include considering the usage of a separate low-power wake-up receiver at the UE, and evaluate how that can reduce the UE power consumption.

One intention of proposed invention as described herein is to improve on at least these operations.

### SUMMARY

This section contains examples of possible implementations and is not meant to be limiting.

In an example aspect of the invention, there is an apparatus, such as a user equipment side apparatus, comprising: at least one processor; and at least one non-transitory memory storing instructions, that when executed by the at least one processor, cause the apparatus at least to: receive, by a user equipment from a network node of a communication network, at least one of a beacon, synchronization signal, or reference signal comprising an indication of a paging occurrence, wherein the at least one of a beacon, synchronization signal, or reference signal comprises a pseudo noise sequence as an indication of the paging occurrence, wherein the at least one of a beacon, synchronization signal, or reference signal is addressed to all user equipment of a group or sub-group of user equipment in at least one cell of the communication network, and wherein the at least one of a beacon, synchronization signal, or reference signal comprises a paging arrival for a common cause, and wherein at least one user equipment of the group or sub-group of user equipment is in one of a sleep mode or powered off; and based on the at least one of a beacon, synchronization signal, or reference signal, wake from the sleep mode or power on to decode the at least one of a beacon, synchronization signal, or reference signal and receive the paging occurrence.

In still another example aspect of the invention, there is a method, comprising: receiving, by a user equipment from a network node of a communication network, at least one of a beacon, synchronization signal, or reference signal comprising an indication of a paging occurrence, wherein the at least one of a beacon, synchronization signal, or reference signal comprises a pseudo noise sequence as an indication of the paging occurrence, wherein the at least one of a beacon, synchronization signal, or reference signal is addressed to all user equipment of a group or sub-group of user equipment in at least one cell of the communication network, and wherein the at least one of a beacon, synchronization signal, or reference signal comprises a paging arrival for a common cause, and wherein at least one user equipment of the group or sub-group of user equipment is in one of a sleep mode or powered off; and based on the at least one of a beacon, synchronization signal, or reference signal, waking from the sleep mode or power on to decode the at least one of a beacon, synchronization signal, or reference signal and receive the paging occurrence.

A further example embodiment is an apparatus and a method comprising the apparatus and the method of the previous paragraphs, wherein the at least one of a beacon, synchronization signal, or reference signal is received by the group or sub-group of user equipment with a low-power wake-up receiver, wherein the at least one of a beacon, synchronization signal, or reference signal is addressed to the group or sub-group of user equipment, and wherein waking from sleep mode or powering on to decode the at least one of a beacon, synchronization signal, or reference signal is based on the user equipment being common to the group or sub-group of user equipment, wherein the at least one of a beacon, synchronization signal, or reference signal comprises an m-sequence or Walsh code fitting with on-off keying and at least one frequency shift keying modulation, wherein the paging occurrence comprises a paging arrival for any common cause message comprising at least one of a common cause message, an emergency page message or a system information change intended for the group or sub-group of user equipment, and wherein waking from sleep mode or powering on to decode the at least one of a beacon, synchronization signal, or reference signal is based on the paging arrival for the common cause emergency page message or the system information change, wherein the at least one of a beacon, synchronization signal, or reference signal comprises at least one predetermined binary sequence common to the group or sub-group of user equipment to cause reception of the common cause emergency page message or the system information change across the communication network or in a specific cell of the communication network, wherein the at least one of a beacon, synchronization signal, or reference signal comprises content of the common cause emergency page message or the system information change, wherein the at least one of a beacon, synchronization signal, or reference signal comprises a low power wake-up signal and the common cause emergency page message or the system information change, wherein the at least one predetermined binary sequence is using a high hamming distance to enable intended sequence detection, wherein there is receiving from the communication network a configuration with a dedicated time and frequency location to monitor for the at least one of a beacon, synchronization signal, or reference signal, and/or wherein the configuration is received via at least one of system information blocks or dedicated signaling.

A non-transitory computer-readable medium storing program code, the program code executed by at least one processor to perform at least the method as described in the paragraphs above.

In yet another example aspect of the invention, there is an apparatus comprising: means for receiving, by a user equipment from a network node of a communication network, at least one of a beacon, synchronization signal, or reference signal comprising an indication of a paging occurrence, wherein the at least one of a beacon, synchronization signal, or reference signal comprises a pseudo noise sequence as an indication of the paging occurrence, wherein the at least one of a beacon, synchronization signal, or reference signal is addressed to all user equipment of a group or sub-group of user equipment in at least one cell of the communication network, and wherein the at least one of a beacon, synchronization signal, or reference signal comprises a paging arrival for a common cause, and wherein at least one user equipment of the group or sub-group of user equipment is in one of a sleep mode or powered off; and means, based on the at least one of a beacon, synchronization signal, or reference signal, for waking from the sleep mode or power on to decode the at least one of a beacon, synchronization signal, or reference signal and receive the paging occurrence.

In accordance with the example embodiments as described in the paragraph above, at least the means for receiving and waking comprises a network interface, and computer program code stored on a computer-readable medium and executed by at least one processor.

In another example aspect of the invention, there is an apparatus, such as a network side apparatus, comprising: at least one processor; and at least one non-transitory memory storing instructions, that when executed by the at least one processor, cause the apparatus at least to: determine, by a network node of a communication network, at least one of a beacon, synchronization signal, or reference signal comprising an indication of a paging occurrence, wherein the at least one of a beacon, synchronization signal, or reference signal comprises a pseudo noise sequence as an indication of the paging occurrence, wherein the at least one of a beacon, synchronization signal, or reference signal is addressed to all user equipment of a group or sub-group of user equipment in at least one cell of the communication network, and wherein the at least one of a beacon, synchronization signal, or reference signal comprises a paging arrival for a common cause, and based on the determining, send towards at least one user equipment of the group or sub-group of user equipment information comprising the at least one of a beacon, synchronization signal, or reference signal to cause the at least one user equipment to decode the at least one of a beacon, synchronization signal, or reference signal for reception of a paging occurrence.

In still another example aspect of the invention, there is a method, comprising: determining, by a network node of a communication network, at least one of a beacon, synchronization signal, or reference signal comprising an indication of a paging occurrence, wherein the at least one of a beacon, synchronization signal, or reference signal comprises a pseudo noise sequence as an indication of the paging occurrence, wherein the at least one of a beacon, synchronization signal, or reference signal is addressed to all user equipment of a group or sub-group of user equipment in at least one cell of the communication network, and wherein the at least one of a beacon, synchronization signal, or reference signal comprises a paging arrival for a common cause, and based on the determining, sending towards at least one user equipment of the group or sub-group of user equipment information comprising the at least one of a beacon, synchronization signal, or reference signal to cause the at least one user equipment to decode the at least one of a beacon, synchronization signal, or reference signal for reception of a paging occurrence.

A further example embodiment is an apparatus and a method comprising the apparatus and the method of the previous paragraphs, wherein the user equipment is in one of a sleep mode or powered off, and wherein the at least one of a beacon, synchronization signal, or reference signal causes user equipment to wake from a sleep mode or power on to decode the at least one of a beacon, synchronization signal, or reference signal and receive the paging occurrence, wherein the at least one of a beacon, synchronization signal, or reference signal is addressed to a user equipment grouping, and wherein waking from sleep mode or powering on to decode the at least one of a beacon, synchronization signal, or reference signal is based on the at least one user equipment being common to the group or sub-group of user equipment, wherein the at least one of a beacon, synchronization signal, or reference signal comprises a pseudo noise sequence as an indication of the paging occurrence, wherein the at least one of a beacon, synchronization signal, or reference signal comprises an m-sequence or Walsh code fitting with on-off keying and at least one frequency shift keying modulation, wherein the paging occurrence comprises a paging arrival for any common cause comprising one of a common cause message, an emergency page message or a system information change intended for the group or sub-group of user equipment, and wherein waking from sleep mode or powering on to decode the at least one of a beacon, synchronization signal, or reference signal is based on the paging arrival for the common cause emergency page message or the system information change, wherein the at least one of a beacon, synchronization signal, or reference signal comprises at least one predetermined binary sequence common to user equipment to cause reception of the common cause emergency page message or the system information change across the communication network or in a specific cell of the communication network, wherein the at least one of a beacon, synchronization signal, or reference signal comprises content of the common cause emergency page message or the system information change, wherein the at least one of a beacon, synchronization signal, or reference signal comprises a low power wake-up signal and the common cause emergency page message or the system information change, wherein the at least one predetermined binary sequence is using a high hamming distance to enable intended sequence detection, wherein there is sending from the communication network towards the user equipment a configuration with a dedicated time and frequency location to monitor for the at least one of a beacon, synchronization signal, or reference signal, and/or wherein the configuration is sent via at least one of system information blocks or dedicated signaling.

A non-transitory computer-readable medium storing program code, the program code executed by at least one processor to perform at least the method as described in the paragraphs above.

In yet another example aspect of the invention, there is an apparatus comprising: means for determining, by a network node of a communication network, at least one of a beacon, synchronization signal, or reference signal comprising an indication of a paging occurrence, wherein the at least one of a beacon, synchronization signal, or reference signal comprises a pseudo noise sequence as an indication of the paging occurrence, wherein the at least one of a beacon, synchronization signal, or reference signal is addressed to all user equipment of a group or sub-group of user equipment in at least one cell of the communication network, and wherein the at least one of a beacon, synchronization signal, or reference signal comprises a paging arrival for a common cause, and means, based on the determining, for sending towards at least one user equipment of the group or sub-group of user equipment information comprising the at least one of a beacon, synchronization signal, or reference signal to cause the at least one user equipment to decode the at least one of a beacon, synchronization signal, or reference signal for reception of a paging occurrence.

In accordance with the example embodiments as described in the paragraph above, at least the means for determining and sending comprises a network interface, and computer program code stored on a computer-readable medium and executed by at least one processor.

A communication system comprising the network side apparatus and the user equipment side apparatus performing operations as described above.

### BRIEF DESCRIPTION OF THE DRAWINGS

The above and other aspects, features, and benefits of various embodiments of the present disclosure will become more fully apparent from the following detailed description with reference to the accompanying drawings, in which like reference signs are used to designate like or equivalent elements. The drawings are illustrated for facilitating better understanding of the embodiments of the disclosure and are not necessarily drawn to scale, in which:

FIG. 1 shows UE operations with low-power wake-up receiver (WUR);

FIG. 2 shows LP-WUS operations for group wise indication of paging arrival;

FIG. 3 shows UE operations with low-power wake-up receiver (WUR);

FIG. 4 shows a proposed LP-SS/BEACON in accordance with example embodiments of the invention for Common cause like emergency indication;

FIG. 5 shows a high level block diagram of various devices used in carrying out various aspects of the invention; and

FIG. 6A and FIG. 6B each show a method in accordance with example embodiments of the invention which may be performed by an apparatus.

### DETAILED DESCRIPTION

In example embodiments of this invention there is proposed at least a method and apparatus for a new method where a Network can send an indication of paging arrival to all or maximum number of user equipment in a single low power wake up signal (LP-WUS) occasion in case of common paging cause like emergency.

Example embodiments of this invention relate to enhancements for UE energy savings in 5G NR, and particularly focuses on UEs/devices which have battery life time targets of weeks or even years.

This includes devices without a continuous energy source, e.g., UEs using small rechargeable and non-rechargeable single coin cell batteries, such as those used for vertical use cases (including sensors and actuators that are deployed extensively for monitoring, measuring, charging, etc.). Generally, their batteries are not rechargeable and expected to last at least few years. Additionally, this includes also wearables such as smart watches, rings, eHealth related devices, and medical monitoring devices, for which it is challenging to sustain up to 1-2 weeks, as required, with typical battery capacity.

Some of the UE types named above (e.g. sensors, actuators and wearables), not only require a long battery life, but also require latency-critical services (such as sensors for fire detection and extinguishing, to name an example). Therefore, solutions such as eDRX (allowing to extend the periodicity by which the UE wakes up to monitor for paging, which in turn reduces the average power consumption) are not applicable as eDRX would lead to unacceptable communication latency.

In 3GPP 4G/LTE and 5G/NR wireless communication systems, a UE in an idle (e.g., radio resource control (RRC) IDLE) or inactive (e.g., RRC_INACTIVE) state may be paged. If a UE receives a page, the UE may then decide to transition to an active state and await further communication from a RAN or CN.

A UE in an idle or inactive state may periodically wake up in accord with a paging cycle and monitor a paging occasion (e.g., during one or more time and frequency resources) to determine whether it has been paged. Further, the UE may monitor a paging occasion associated with a paging subgroup that has been assigned to the UE. A paging cycle is measured in terms of radio frames.

Every time a UE wakes up to monitor a paging occasion (PO), the UE consumes relatively more power than when it is asleep (i.e., in a low power state). For a battery-operated UE, greater power consumption reduces the UE's remaining battery life. This sometimes provides a user with a less satisfactory user experience. There is desired methods and apparatus that can reduce power consumed by a UE. In particular, the described systems, methods, and apparatus enable a wireless communication device (e.g., a UE) to be assigned to a paging subgroup which, in some cases, may allow the UE to wake up comparatively less frequently to monitor a paging occasion, thereby reducing the UE's power consumption.

One standards study item on low-power Wake-Up Signal has been approved at the time of this application to enable further UE power saving for devices such as the above mentioned device types, and includes the objectives listed below. This invention is related to the highlighted objective, which targets to study and evaluate the procedural changes, which are needed to support the WUS.

The study item includes the following objectives:
Identify evaluation methodology (including the use cases) & KPIs [RAN1]:
   Primarily target low-power WUS/WUR for power-sensitive, small form-factor devices including IoT use cases (such as industrial sensors, controllers) and wearables,
      Other use cases are not precluded;
Study and evaluate low-power wake-up receiver architectures [RAN1, RAN4];
Study and evaluate wake-up signal designs to support wake-up receivers [RAN1, RAN4];
Study and evaluate L1 procedures and higher layer protocol changes needed to support the wake-up signals [RAN2, RAN1];
Study potential UE power saving gains compared to the existing standards UE power saving mechanisms and their coverage availability, as well as latency impact. System impact, such as network power consumption, coexistence with non-low-power-WUR UEs, network coverage/capacity/resource overhead should be included in the study items.
Note: The need for RAN2 evaluation will be triggered by RAN1 when necessary.

The study will consider the usage of a separate low-power wake-up receiver at the UE, and evaluate how that can reduce the UE power consumption. The intention is that the main radio of the UE can be in a sleep mode (or even powered off) for power saving and be activated only upon the reception of the wake-up signal from the network.

The assumption is that the low-power wake-up receiver can be operated in an always ‘on’ or duty cycled manner with very low power consumption. In fact, it is expected that it will consume significantly less power compared to the NR transceiver, by designing a simple (WUS) signal and the use of dedicated hardware for its monitoring, which is only able to receive the WUS.

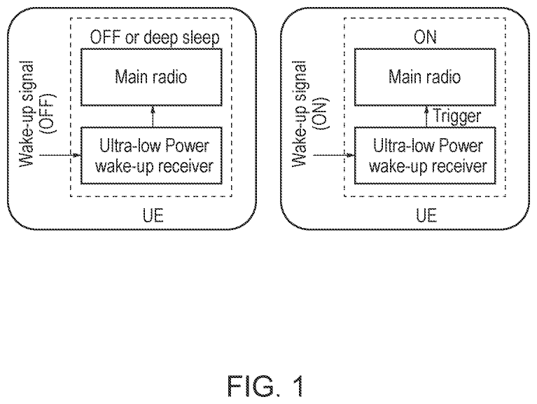

FIG. 1 shows UE operations with low-power wake-up receiver (WUR). As shown in FIG. 1 on the left side is a wake-up signal (off) signal to an ultra-low power wake-up receiver then sent to a main radio that is off or deep sleeping. As shown in FIG. 1 on the right side is a wake-up signal (on) signal to an ultra-low power wake-up receiver then a trigger sent to a main radio that is on.

In LP-WUS mode of operation: In idle/In-active state, UE is expected to wake up occasionally to detect/decode the indication of paging arrival i.e., LP-WUS. To increase the power saving and optimize the LP-WUS resources, NW shall categorize UEs in different groups and configure UEs to monitors certain LP-WUS occasions only to detect/decode the associated LP-WUS. So NW will send LP-WUS as indication of paging arrival to a UE in certain LP-WUS occasions (associated with that particular UE group) only and UE is expected to monitor those certain occasions only as indication of paging arrivals.

Considering above mechanism of LP-WUS paging, If NW wants to page all the UE's for any common purpose like emergency cause, NW has to transmit LP-WUS as indication for paging arrival with common cause like emergency, over at least one instance of each groups.

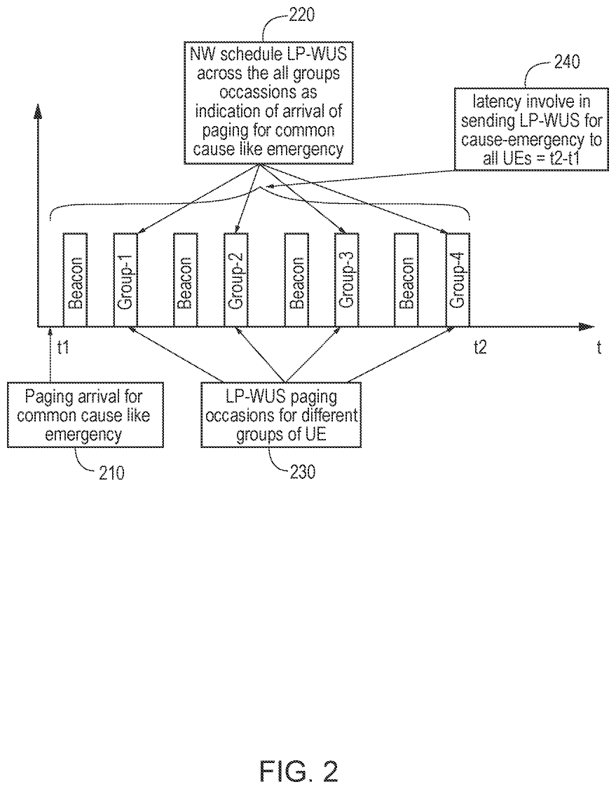

As shown in FIG. 2, NW has categorized UEs in 4 LP-WUS groups 1, 2, 3 and 4. At instance t1, NW wants to schedule LP-WUS as indication of paging arrival for (common cause) emergency. As per legacy way, NW must schedule LP-WUS as arrival of paging indication-NW has to schedule LP-WUS over at least one instance of each LP-WUS group.

As shown in step 210 of FIG. 2 there is at T1 a paging arrival for a common cause such as but not limited to an emergency common cause. As shown in step 220 of FIG. 2 the network (NW) schedules LP-WUS across all group occasions e.g., Group-1, Group-2, and Group-2, as indication of arrival of paging for common cause such as but not limited to an emergency common cause. As shown in step 230 of FIG. 2 there is received LP-WUS paging occasions up to T2 for different groups of UE. Then as shown in step 240 of FIG. 2 there is noted latency involved in sending LP-WUS for common cause such as emergency common cause to all UEs T2−T1.

One intention of proposed invention is to enable the network (NW) to send an indication of paging arrival to all or maximum number of UEs in a single LP-WUS occasion in case of common paging cause such as but not limited to emergency.

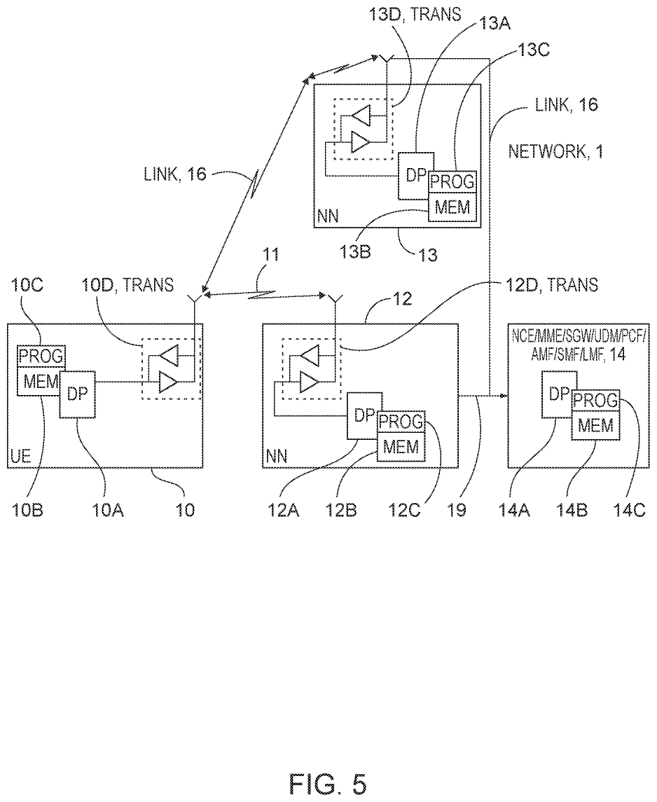

Before describing the example embodiments as disclosed herein in detail, reference is made to FIG. 5 for illustrating a simplified block diagram of various electronic devices that are suitable for use in practicing the example embodiments of this invention.

FIG. 5 shows a block diagram of one possible and non-limiting exemplary system in which the example embodiments may be practiced. In FIG. 5, a user equipment (UE) 10 is in wireless communication with a wireless network 1 or network, 1 as in FIG. 5. The wireless network 1 or network 1 as in FIG. 5 can comprise a communication network such as a mobile network e.g., the mobile network 1 or first mobile network as disclosed herein. Any reference herein to a wireless network 1 as in FIG. 5 can be seen as a reference to any wireless network as disclosed herein. Further, the wireless network 1 as in FIG. 5 can also comprises hardwired features as may be required by a communication network. A UE is a wireless, typically mobile device that can access a wireless network. The UE, for example, may be a mobile phone (or called a “cellular” phone) and/or a computer with a mobile terminal function. For example, the UE or mobile terminal may also be a portable, pocket, handheld, computer-embedded or vehicle-mounted mobile device and performs a language signaling and/or data exchange with the RAN.

The UE 10 includes one or more processors DP 10A, one or more memories MEM 10B, and one or more transceivers TRANS 10D interconnected through one or more buses. Each of the one or more transceivers TRANS 10D includes a receiver and a transmitter. The one or more buses may be address, data, or control buses, and may include any interconnection mechanism, such as a series of lines on a motherboard or integrated circuit, fiber optics or other optical communication equipment, and the like. The one or more transceivers TRANS 10D which can be optionally connected to one or more antennas for communication to NN 12 and NN 13, respectively. The one or more memories MEM 10B include computer program code PROG 10C. The UE 10 communicates with NN 12 and/or NN 13 via a wireless link 11 or 16.

The NN 12 (NR/5G Node B, an evolved NB, or LTE device) is a network node such as a master or secondary node base station (e.g., for NR or LTE long term evolution) that communicates with devices such as NN 13 and UE 10 of FIG. 5. The NN 12 provides access to wireless devices such as the UE 10 to the wireless network 1. The NN 12 includes one or more processors DP 12A, one or more memories MEM 12B, and one or more transceivers TRANS 12D interconnected through one or more buses. In accordance with the example embodiments these TRANS 12D can include X2 and/or Xn interfaces for use to perform the example embodiments. Each of the one or more transceivers TRANS 12D includes a receiver and a transmitter. The one or more transceivers TRANS 12D can be optionally connected to one or more antennas for communication over at least link 11 with the UE 10. The one or more memories MEM 12B and the computer program code PROG 12C are configured to cause, with the one or more processors DP 12A, the NN 12 to perform one or more of the operations as described herein. The NN 12 may communicate with another gNB or eNB, or a device such as the NN 13 such as via link 16. Further, the link 11, link 16 and/or any other link may be wired or wireless or both and may implement, e.g., an X2 or Xn interface. Further the link 11 and/or link 16 may be through other network devices such as, but not limited to an NCE/MME/SGW/UDM/PCF/AMF/SMF/LMF 14 device as in FIG. 5. The NN 12 may perform functionalities of an MME (Mobility Management Entity) or SGW (Serving Gateway), such as a User Plane Functionality, and/or an Access Management functionality for LTE and similar functionality for 5G.

The NN 13 can be for WiFi or Bluetooth or other wireless device associated with a mobility function device such as an AMF or SMF, further the NN 13 may comprise a NR/5G Node B or possibly an evolved NB a base station such as a master or secondary node base station (e.g., for NR or LTE long term evolution) that communicates with devices such as the NN 12 and/or UE 10 and/or the wireless network 1. The NN 13 includes one or more processors DP 13A, one or more memories MEM 13B, one or more network interfaces, and one or more transceivers TRANS 13D interconnected through one or more buses. In accordance with the example embodiments these network interfaces of NN 13 can include X2 and/or Xn interfaces for use to perform the example embodiments. Each of the one or more transceivers TRANS 13D includes a receiver and a transmitter that can optionally be connected to one or more antennas. The one or more memories MEM 13B include computer program code PROG 13C. For instance, the one or more memories MEM 13B and the computer program code PROG 13C are configured to cause, with the one or more processors DP 13A, the NN 13 to perform one or more of the operations as described herein. The NN 13 may communicate with another mobility function device and/or eNB such as the NN 12 and the UE 10 or any other device using, e.g., link 11 or link 16 or another link. The Link 16 as shown in FIG. 5 can be used for communication with the NN 12. These links maybe wired or wireless or both and may implement, e.g., an X2 or Xn interface. Further, as stated above the link 11 and/or link 16 may be through other network devices such as, but not limited to an NCE/MME/SGW device such as the NCE/MME/SGW/UDM/PCF/AMF/SMF/LMF 14 of FIG. 5.

The one or more buses of the device of FIG. 5 may be address, data, or control buses, and may include any interconnection mechanism, such as a series of lines on a motherboard or integrated circuit, fiber optics or other optical communication equipment, wireless channels, and the like. For example, the one or more transceivers TRANS 12D, TRANS 13D and/or TRANS 10D may be implemented as a remote radio head (RRH), with the other elements of the NN 12 being physically in a different location from the RRH, and these devices can include one or more buses that could be implemented in part as fiber optic cable to connect the other elements of the NN 12 to a RRH.

It is noted that although FIG. 5 shows a network nodes such as NN 12 and NN 13, any of these nodes may can incorporate or be incorporated into an eNodeB or eNB or gNB such as for LTE and NR, and would still be configurable to perform example embodiments.

Also it is noted that description herein indicates that “cells” perform functions, but it should be clear that the gNB that forms the cell and/or a user equipment and/or mobility management function device that will perform the functions. In addition, the cell makes up part of a gNB, and there can be multiple cells per gNB.

The wireless network 1 or any network it can represent may or may not include a NCE/MME/SGW/UDM/PCF/AMF/SMF/LMF 14 that may include (NCE) network control element functionality, MME (Mobility Management Entity)/SGW (Serving Gateway) functionality, and/or serving gateway (SGW), and/or MME (Mobility Management Entity) and/or SGW (Serving Gateway) functionality, and/or user data management functionality (UDM), and/or PCF (Policy Control) functionality, and/or Access and Mobility Management Function (AMF) functionality, and/or Session Management (SMF) functionality, and/or Location Management Function (LMF), and/or Authentication Server (AUSF) functionality and which provides connectivity with a further network, such as a telephone network and/or a data communications network (e.g., the Internet), and which is configured to perform any 5G and/or NR operations in addition to or instead of other standard operations at the time of this application. The NCE/MME/SGW/UDM/PCF/AMF/SMF/LMF 14 is configurable to perform operations in accordance with example embodiments in any of an LTE, NR, 5G and/or any standards based communication technologies being performed or discussed at the time of this application. In addition, it is noted that the operations in accordance with example embodiments, as performed by the NN 12 and/or NN 13, may also be performed at the NCE/MME/SGW/UDM/PCF/AMF/SMF/LMF 14.

The NCE/MME/SGW/UDM/PCF/AMF/SMF/LMF 14 includes one or more processors DP 14A, one or more memories MEM 14B, and one or more network interfaces (N/W I/F(s)), interconnected through one or more buses coupled with the link 13 and/or link 16. In accordance with the example embodiments these network interfaces can include X2 and/or Xn interfaces for use to perform the example embodiments. The one or more memories MEM 14B include computer program code PROG 14C. The one or more memories MEM 14B and the computer program code PROG 14C are configured to, with the one or more processors DP 14A, cause the NCE/MME/SGW/UDM/PCF/AMF/SMF/LMF 14 to perform one or more operations which may be needed to support the operations in accordance with the example embodiments.

It is noted that that the NN 12 and/or NN 13 and/or UE 10 can be configured (e.g. based on standards implementations etc.) to perform functionality of a Location Management Function (LMF). The LMF functionality may be embodied in any of these network devices or other devices associated with these devices. In addition, an LMF such as the LMF of the MME/SGW/UDM/PCF/AMF/SMF/LMF 14 of FIG. 5, as at least described below, can be co-located with UE 10 such as to be separate from the NN 12 and/or NN 13 of FIG. 5 for performing operations in accordance with example embodiments as disclosed herein.

The wireless Network 1 may implement network virtualization, which is the process of combining hardware and software network resources and network functionality into a single, software-based administrative entity, a virtual network. Network virtualization involves platform virtualization, often combined with resource virtualization. Network virtualization is categorized as either external, combining many networks, or parts of networks, into a virtual unit, or internal, providing network-like functionality to software containers on a single system. Note that the virtualized entities that result from the network virtualization are still implemented, at some level, using hardware such as processors DP 10, DP 12A, DP 13A, and/or DP 14A and memories MEM 10B, MEM 12B, MEM 13B, and/or MEM 14B, and also such virtualized entities create technical effects.

The computer readable memories MEM 12B, MEM 13B, and MEM 14B may be of any type suitable to the local technical environment and may be implemented using any suitable data storage technology, such as semiconductor based memory devices, flash memory, magnetic memory devices and systems, optical memory devices and systems, fixed memory and removable memory. The computer readable memories MEM 12B, MEM 13B, and MEM 14B may be means for performing storage functions. The processors DP 10, DP 12A, DP 13A, and DP 14A may be of any type suitable to the local technical environment, and may include one or more of general purpose computers, special purpose computers, microprocessors, digital signal processors (DSPs) and processors based on a multi-core processor architecture, as non-limiting examples. The processors DP 10, DP 12A, DP 13A, and DP 14A may be means for performing functions, such as controlling the UE 10, NN 12, NN 13, and other functions as described herein.

In general, various embodiments of any of these devices can include, but are not limited to, cellular telephones such as smart phones, tablets, personal digital assistants (PDAs) having wireless communication capabilities, portable computers having wireless communication capabilities, image capture devices such as digital cameras having wireless communication capabilities, gaming devices having wireless communication capabilities, music storage and playback appliances having wireless communication capabilities, Internet appliances permitting wireless Internet access and browsing, tablets with wireless communication capabilities, as well as portable units or terminals that incorporate combinations of such functions.

Further, the various embodiments of any of these devices can be used with a UE vehicle, a High Altitude Platform Station, or any other such type node associated with a terrestrial network or any drone type radio or a radio in aircraft or other airborne vehicle or a vessel that travels on water such as a boat.

As similarly stated above, One intention of proposed invention is to enable NW to send an indication of paging arrival to all or maximum number of UEs in a single LP-WUS occasion in case of common paging cause like emergency.

It is being discussed to transmit Low power reference signal (so called LP Beacon) to keep the LR in sync with NW. These LP reference signals/LP-Beacon is common to all UEs. So all UEs are expected to detect/decode these LP reference signals. Thus, this LP reference signal is an opportunity to NW to address all the UEs for a common cause like emergency at once. So proposed solution in this invention report is to use LP-reference signal/LP-beacon to schedule LP-WUS for common cause like emergency. As an alternative solution a dedicated LP-WUS can be sent on the location of the LP-Beacon with the content of the emergency information.

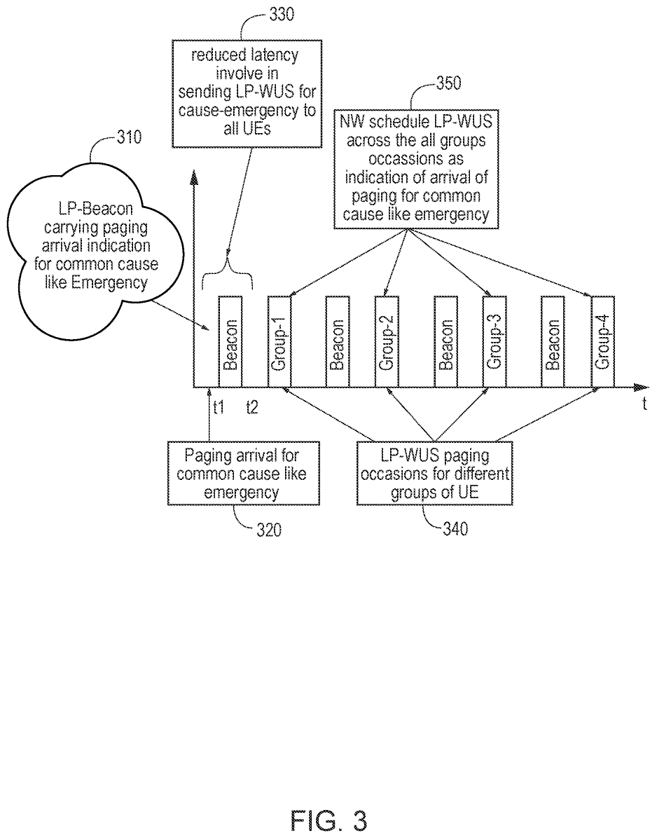

FIG. 3 has clearly depicted that one of the LP-Beacon (very first instance) has been constructed with indication of paging arrival with cause-emergency. As all the UEs are expected to detect/decode LP-reference/LP-Beacon, LP-WUS can be conveyed to all the UEs at one instance of LP-Beacon. NW can (optionally) repeat the indication of paging arrival over other LP-SS/LP-BEACON and schedule the LP-SS/LP-BEACON over all the occasions of all groups as well.

There could be instances where any of the LP-WUS groups paging occurrence/s are earlier to LP-WUS-SS/Beacon, NW can still choose to send indication for paging arrival over those occurrences too. It will give faster indication to UEs belonging to that group. NW can further send indication for paging arrival over nearest LP-SS/beacon to reach out all/max. UEs at earliest.

As shown in step 310 of FIG. 3 there is an LP-Beacon carrying paging arrival indication for common cause such as but not limited to an emergency common cause. As shown in step 320 of FIG. 3 there is at T1 a paging arrival for common cause such as but not limited to an emergency common cause. As shown in step 330 of FIG. 3 there is noted reduced latency involved in sending LP-WUS for common cause such as emergency common cause to all UEs T1−T2. As shown in step 340 of FIG. 3 there is LP-WUS paging occasion for different groupings of UE. Then as shown in step 350 of FIG. 3 the network (NW) schedules LP-WUS across all group occasions as indication of arrival of paging for common cause such as but not limited to an emergency common cause.

FIG. 3 has clearly depicted that latency involved in addressing LP-WUS as indication of paging arrival to all the UEs, has significantly reduced.

Proposed idea provides easily detectable LP reference signal (LP-SS/P_Beacon/LP-reference signal) which can serve the purpose of indication of arrival of paging in RRC idle/in-active state LP-WUS mode of operation.

FIG. 3, clearly depicts that proposed idea “LP reference signal (beacon) for indication of paging arrival of all the UEs for common purpose like emergency cause”, could improve overall latency to address all the UEs in single instance.

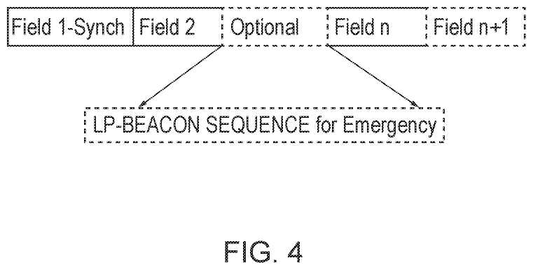

FIG. 4, depicts possible structure of LP reference signal/beacon with optional field for common cause like emergency.

As shown in FIG. 4 there is an optional field in LP-SS/BEACON that could contain unique PN sequence that be an indication of paging arrival of common cause like emergency.

M-sequence or Walsh code will fit with OOK and FSK (different FSK) modulation and simple to construct & having high reliability of detection could fit for emergency paging indication sequence.

Binary sequences with high Hamming distance will enable LR to detect intended sequence even with few errors, (non-perfect correlation could also serve the purpose).

It is up to NW implementations that to keep a common unique sequence for common cause like “emergency” across NW or cell specific.

Alternatively, the NW could configure a dedicated time and frequency location for devices to monitor for this specific emergency LP-SS/Beacon signal.

NW can inform to devices about unique sequences for common cause via SIBs or dedicated signaling.

Alternatively could the LP-SS/BEACON for Common cause like emergency indication be a dedicated LP-WUS with the emergency indication only.

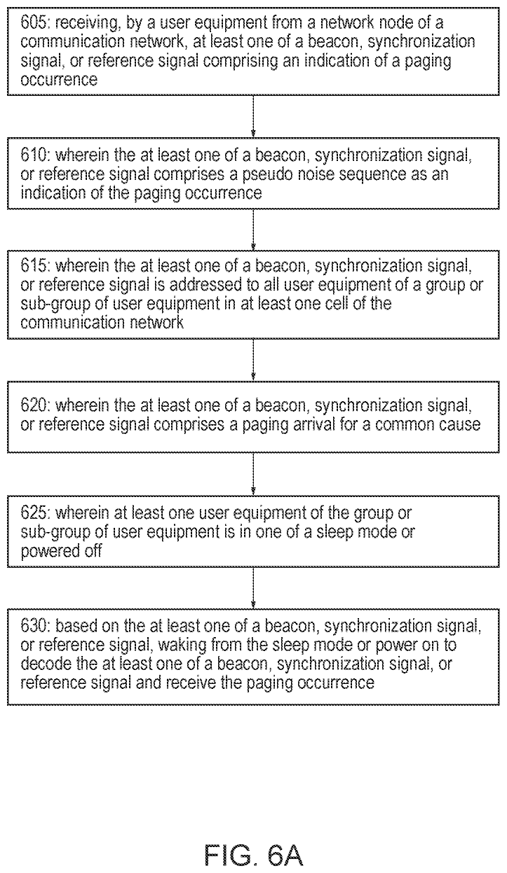

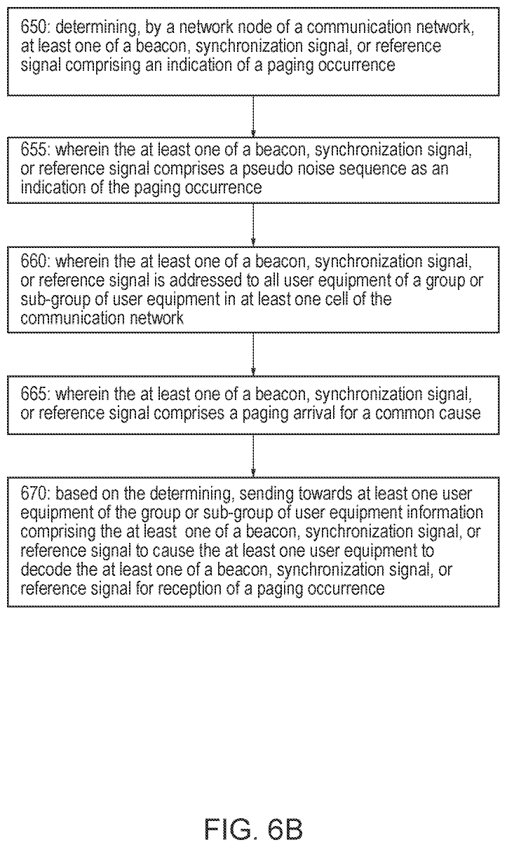

FIG. 6A and FIG. 6B each show a method in accordance with example embodiments of the invention which may be performed by an apparatus.

FIG. 6A illustrates operations which may be performed by a device such as, but not limited to, a device such as a network device (e.g., the UE 10 as in FIG. 5). As shown in step 605 of FIG. 6A there is receiving, by a user equipment from a network node of a communication network, at least one of a beacon, synchronization signal, or reference signal comprising an indication of a paging occurrence. As shown in step 610 of FIG. 6A there is wherein the at least one of a beacon, synchronization signal, or reference signal comprises a pseudo noise sequence as an indication of the paging occurrence. As shown in step 615 of FIG. 6A there is wherein the at least one of a beacon, synchronization signal, or reference signal is addressed to all user equipment of a group or sub-group of user equipment in at least one cell of the communication network. As shown in step 620 of FIG. 6A there is wherein the at least one of a beacon, synchronization signal, or reference signal comprises a paging arrival for a common cause. As shown in step 625 of FIG. 6A there is wherein at least one user equipment of the group or sub-group of user equipment is in one of a sleep mode or powered off. Then as shown in step 630 of FIG. 6A there is, based on the at least one of a beacon, synchronization signal, or reference signal, waking from the sleep mode or power on to decode the at least one of a beacon, synchronization signal, or reference signal and receive the paging occurrence.

In accordance with the example embodiments as described in the paragraph above, wherein the at least one of a beacon, synchronization signal, or reference signal is received by the group or sub-group of user equipment with a low-power wake-up receiver.

In accordance with the example embodiments as described in the paragraphs above, wherein the at least one of a beacon, synchronization signal, or reference signal is addressed to the group or sub-group of user equipment, and wherein waking from sleep mode or powering on to decode the at least one of a beacon, synchronization signal, or reference signal is based on the user equipment being common to the group or sub-group of user equipment.

In accordance with the example embodiments as described in the paragraphs above, wherein the at least one of a beacon, synchronization signal, or reference signal comprises an m-sequence or Walsh code fitting with on-off keying and at least one frequency shift keying modulation.

In accordance with the example embodiments as described in the paragraphs above, wherein the paging occurrence comprises a paging arrival for a common cause comprising one of an emergency page message or a system information change intended for the group or sub-group of user equipment.

In accordance with the example embodiments as described in the paragraphs above, wherein waking from sleep mode or powering on to decode the at least one of a beacon, synchronization signal, or reference signal is based on the paging arrival for the common cause emergency page message or the system information change.

In accordance with the example embodiments as described in the paragraphs above, wherein the at least one of a beacon, synchronization signal, or reference signal comprises at least one predetermined binary sequence common to the group or sub-group of user equipment to cause reception of the common cause emergency page message or the system information change across the communication network or in a specific cell of the communication network.

In accordance with the example embodiments as described in the paragraphs above, wherein the at least one of a beacon, synchronization signal, or reference signal comprises content of the common cause emergency page message or the system information change.

In accordance with the example embodiments as described in the paragraphs above, wherein the at least one of a beacon, synchronization signal, or reference signal comprises a low power wake-up signal and the common cause emergency page message or the system information change.

In accordance with the example embodiments as described in the paragraphs above, wherein the at least one predetermined binary sequence is using a high hamming distance to enable intended sequence detection.

In accordance with the example embodiments as described in the paragraphs above, wherein there is receive from the communication network a configuration with a dedicated time and frequency location to monitor for the at least one of a beacon, synchronization signal, or reference signal.

In accordance with the example embodiments as described in the paragraphs above, wherein the configuration is received via at least one of system information blocks or dedicated signaling.

A non-transitory computer-readable medium (MEM 10B as in FIG. 5) storing program code (PROG 10C of as in FIG. 5), the program code executed by at least one processor (DP 10A as in FIG. 5) to perform the operations as at least described in the paragraphs above.

In accordance with an example embodiment of the invention as described above there is an apparatus comprising: means for receiving (one or more transceivers 10D; MEM 10B; PROG 10C; and DP 10A as in FIG. 5), by a user equipment (UE 10 as in FIG. 5) from a network node (NN 12 and/or NN 13 as in FIG. 5) of a communication network (Network 1 as in FIG. 5), at least one of a beacon, synchronization signal, or reference signal comprising an indication of a paging occurrence, wherein the at least one of a beacon, synchronization signal, or reference signal comprises a pseudo noise sequence as an indication of the paging occurrence, wherein the at least one of a beacon, synchronization signal, or reference signal is addressed (one or more transceivers 10D; MEM 10B; PROG 10C; and DP 10A as in FIG. 5) to all user equipment of a group or sub-group of user equipment in at least one cell of the communication network, and wherein the at least one of a beacon, synchronization signal, or reference signal comprises a paging arrival for a common cause, and wherein at least one user equipment of the group or sub-group of user equipment is in one of a sleep mode or powered off (one or more transceivers 10D; MEM 10B; PROG 10C; and DP 10A as in FIG. 5); and based on the at least one of a beacon, synchronization signal, or reference signal, waking (one or more transceivers 10D; MEM 10B; PROG 10C; and DP 10A as in FIG. 5) from the sleep mode or power on to decode the at least one of a beacon, synchronization signal, or reference signal and receive the paging occurrence.

In the example aspect according to the paragraph above, wherein at least the means for receiving, addressing, sleep mode, powered off, and waking comprises a non-transitory computer readable medium [MEM 10B as in FIG. 5] encoded with a computer program [PROG 10C as in FIG. 5] executable by at least one processor [DP 10A as in FIG. 5].

FIG. 6B illustrates operations which may be performed by a device such as, but not limited to, a device such as a network device (e.g., the NN 12 and/or NN 13 as in FIG. 5). As shown in step 650 of FIG. 6B there is determining, by a network node of a communication network, at least one of a beacon, synchronization signal, or reference signal comprising an indication of a paging occurrence. As shown in step 655 of FIG. 6B there is wherein the at least one of a beacon, synchronization signal, or reference signal comprises a pseudo noise sequence as an indication of the paging occurrence. As shown in step 660 of FIG. 6B there is wherein the at least one of a beacon, synchronization signal, or reference signal is addressed to all user equipment of a group or sub-group of user equipment in at least one cell of the communication network. As shown in step 665 of FIG. 6B there is wherein the at least one of a beacon, synchronization signal, or reference signal comprises a paging arrival for a common cause. Then as shown in step 670 of FIG. 6B there is based on the determining, send towards at least one user equipment of the group or sub-group of user equipment information comprising the at least one of a beacon, synchronization signal, or reference signal to cause the at least one user equipment to decode the at least one of a beacon, synchronization signal, or reference signal for reception of a paging occurrence.

In accordance with the example embodiments as described in the paragraphs above, wherein the user equipment is in one of a sleep mode or powered off, and wherein the at least one of a beacon, synchronization signal, or reference signal causes user equipment to wake from a sleep mode or power on to decode the at least one of a beacon, synchronization signal, or reference signal and receive the paging occurrence.

In accordance with the example embodiments as described in the paragraphs above, wherein the at least one of a beacon, synchronization signal, or reference signal is addressed to a user equipment grouping, and wherein waking from sleep mode or powering on to decode the at least one of a beacon, synchronization signal, or reference signal is based on the at least one user equipment being common to the group or sub-group of user equipment.

In accordance with the example embodiments as described in the paragraphs above, wherein the at least one of a beacon, synchronization signal, or reference signal comprises a pseudo noise sequence as an indication of the paging occurrence.

In accordance with the example embodiments as described in the paragraphs above, wherein the at least one of a beacon, synchronization signal, or reference signal comprises an m-sequence or Walsh code fitting with on-off keying and at least one frequency shift keying modulation.

In accordance with the example embodiments as described in the paragraphs above, wherein the paging occurrence comprises a paging arrival for a common cause comprising one of an emergency page message or a system information change intended for the group or sub-group of user equipment.

In accordance with the example embodiments as described in the paragraphs above, wherein waking from sleep mode or powering on to decode the at least one of a beacon, synchronization signal, or reference signal is based on the paging arrival for the common cause emergency page message or the system information change.

In accordance with the example embodiments as described in the paragraphs above, wherein the at least one of a beacon, synchronization signal, or reference signal comprises at least one predetermined binary sequence common to user equipment to cause reception of the common cause emergency page message or the system information change across the communication network or in a specific cell of the communication network.

In accordance with the example embodiments as described in the paragraphs above, wherein the at least one of a beacon, synchronization signal, or reference signal comprises content of the common cause emergency page message or the system information change.

In accordance with the example embodiments as described in the paragraphs above, wherein the at least one of a beacon, synchronization signal, or reference signal comprises a low power wake-up signal and the common cause emergency page message or the system information change.

In accordance with the example embodiments as described in the paragraphs above, wherein the at least one predetermined binary sequence is using a high hamming distance to enable intended sequence detection.

In accordance with the example embodiments as described in the paragraphs above, wherein there is sending from the communication network towards the user equipment a configuration with a dedicated time and frequency location to monitor for the at least one of a beacon, synchronization signal, or reference signal.

In accordance with the example embodiments as described in the paragraphs above, wherein the configuration is sent via at least one of system information blocks or dedicated signaling.

A non-transitory computer-readable medium (MEM 10B as in FIG. 5) storing program code (PROG 10C of as in FIG. 5), the program code executed by at least one processor (DP 10A as in FIG. 5) to perform the operations as at least described in the paragraphs above.

In accordance with an example embodiment of the invention as described above there is an apparatus comprising: means for determining (one or more transceivers 12D and/or 13D; MEM 12B and/or MEM 13B; PROG 12C and/or PROG 13C; and DP 12A and/or DP 13A as in FIG. 5), by a network node (NN 12 and/or NN 13 as in FIG. 5) of a communication network (Network 1 as in FIG. 5), at least one of a beacon, synchronization signal, or reference signal comprising an indication of a paging occurrence, wherein the at least one of a beacon, synchronization signal, or reference signal comprises a pseudo noise sequence (one or more transceivers 12D and/or 13D; MEM 12B and/or MEM 13B; PROG 12C and/or PROG 13C; and DP 12A and/or DP 13A as in FIG. 5) as an indication of the paging occurrence, wherein the at least one of a beacon, synchronization signal, or reference signal is addressed to all user equipment of a group or sub-group of user equipment in at least one cell of the communication network, and wherein the at least one of a beacon, synchronization signal, or reference signal comprises a paging arrival (one or more transceivers 12D and/or 13D; MEM 12B and/or MEM 13B; PROG 12C and/or PROG 13C; and DP 12A and/or DP 13A as in FIG. 5) for a common cause, and means, based on the determining, for sending (one or more transceivers 12D and/or 13D; MEM 12B and/or MEM 13B; PROG 12C and/or PROG 13C; and DP 12A and/or DP 13A as in FIG. 5) towards at least one user equipment of the group or sub-group of user equipment information comprising the at least one of a beacon, synchronization signal, or reference signal to cause the at least one user equipment to decode the at least one of a beacon, synchronization signal, or reference signal for reception of a paging occurrence.

In the example aspect according to the paragraph above, wherein at least the means for receiving, addressing, sleep mode, powered off, and waking comprises a non-transitory computer readable medium [MEM 12B and/or MEM 13B as in FIG. 5] encoded with a computer program [PROG 12C and/or PRO 13C as in FIG. 5] executable by at least one processor [DP 12A and/or DP 13A as in FIG. 5].

### Advantages

Using LP-SS/LP-Beacon for arrival of paging indication for common cause like emergency will at least:
1. Reduced latency for sending LP-WUS for common/emergency paging arrival;
2. M-sequence or Walsh code will fit with OOK and FSK (different FSK) modulation and simple to construct & having high reliability of detection could fit for emergency paging indication sequence; and
3. Binary sequences with high Hamming distance will enable LR to detect intended sequence even with few errors, (non-perfect correlation could also serve the purpose)

Further, in accordance with example embodiments of the invention there is circuitry for performing operations in accordance with example embodiments of the invention as disclosed herein. This circuitry can include any type of circuitry including content coding circuitry, content decoding circuitry, processing circuitry, image generation circuitry, data analysis circuitry, etc.). Further, this circuitry can include discrete circuitry, application-specific integrated circuitry (ASIC), and/or field-programmable gate array circuitry (FPGA), etc. as well as a processor specifically configured by software to perform the respective function, or dual-core processors with software and corresponding digital signal processors, etc.). Additionally, there are provided necessary inputs to and outputs from the circuitry, the function performed by the circuitry and the interconnection (perhaps via the inputs and outputs) of the circuitry with other components that may include other circuitry in order to perform example embodiments of the invention as described herein.

In accordance with example embodiments of the invention as disclosed in this application this application, the “circuitry” provided can include at least one or more or all of the following:
(a) hardware-only circuit implementations (such as implementations in only analog and/or digital circuitry);
(b) combinations of hardware circuits and software, such as (as applicable):
(i) a combination of analog and/or digital hardware circuit(s) with software/firmware; and
(ii) any portions of hardware processor(s) with software (including digital signal processor(s)), software, and memory(ies) that work together to cause an apparatus, such as a mobile phone or server, to perform various functions, such as functions or operations in accordance with example embodiments of the invention as disclosed herein); and
(c) hardware circuit(s) and or processor(s), such as a microprocessor(s) or a portion of a microprocessor(s), that requires software (e.g., firmware) for operation, but the software may not be present when it is not needed for operation.”

In accordance with example embodiments of the invention, there is adequate circuitry for performing at least novel operations in accordance with example embodiments of the invention as disclosed in this application, this ‘circuitry’ as may be used herein refers to at least the following:
(a) hardware-only circuit implementations (such as implementations in only analog and/or digital circuitry); and
(b) to combinations of circuits and software (and/or firmware), such as (as applicable): (i) to a combination of processor(s) or (ii) to portions of processor(s)/software (including digital signal processor(s)), software, and memory(ies) that work together to cause an apparatus, such as a mobile phone or server, to perform various functions); and
(c) to circuits, such as a microprocessor(s) or a portion of a microprocessor(s), that require software or firmware for operation, even if the software or firmware is not physically present.

This definition of ‘circuitry’ applies to all uses of this term in this application, including in any claims. As a further example, as used in this application, the term “circuitry” would also cover an implementation of merely a processor (or multiple processors) or portion of a processor and its (or their) accompanying software and/or firmware. The term “circuitry” would also cover, for example and if applicable to the particular claim element, a baseband integrated circuit or applications processor integrated circuit for a mobile phone or a similar integrated circuit in a server, a cellular network device, or other network device.

In general, the various embodiments may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

Embodiments of the inventions may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

The word “exemplary” is used herein to mean “serving as an example, instance, or illustration.” Any embodiment described herein as “exemplary” is not necessarily to be construed as preferred or advantageous over other embodiments. All of the embodiments described in this Detailed Description are exemplary embodiments provided to enable persons skilled in the art to make or use the invention and not to limit the scope of the invention which is defined by the claims.

The foregoing description has provided by way of exemplary and non-limiting examples a full and informative description of the best method and apparatus presently contemplated by the inventors for carrying out the invention. However, various modifications and adaptations may become apparent to those skilled in the relevant arts in view of the foregoing description, when read in conjunction with the accompanying drawings and the appended claims. However, all such and similar modifications of the teachings of example embodiments of this invention will still fall within the scope of this invention.

It should be noted that the terms “connected,” “coupled,” or any variant thereof, mean any connection or coupling, either direct or indirect, between two or more elements, and may encompass the presence of one or more intermediate elements between two elements that are “connected” or “coupled” together. The coupling or connection between the elements can be physical, logical, or a combination thereof. As employed herein two elements may be considered to be “connected” or “coupled” together by the use of one or more wires, cables and/or printed electrical connections, as well as by the use of electromagnetic energy, such as electromagnetic energy having wavelengths in the radio frequency region, the microwave region and the optical (both visible and invisible) region, as several non-limiting and non-exhaustive examples.

Furthermore, some of the features of the preferred embodiments of this invention could be used to advantage without the corresponding use of other features. As such, the foregoing description should be considered as merely illustrative of the principles of the invention, and not in limitation thereof.

1. An apparatus, comprising:
at least one processor; and
at least one non-transitory memory storing instructions, that when executed by the at least one processor, cause the apparatus at least to:
receive, by a user equipment from a network node of a communication network, at least one of a beacon, synchronization signal, or reference signal comprising an indication of a paging occurrence,
wherein the at least one of a beacon, synchronization signal, or reference signal comprises a pseudo noise sequence as an indication of the paging occurrence,
wherein the at least one of a beacon, synchronization signal, or reference signal is addressed to all user equipment of a group or sub-group of user equipment in at least one cell of the communication network, and
wherein the at least one of a beacon, synchronization signal, or reference signal comprises a paging arrival for a common cause, and
wherein at least one user equipment of the group or sub-group of user equipment is in one of a sleep mode or powered off; and
based on the at least one of a beacon, synchronization signal, or reference signal, wake from the sleep mode or power on to decode the at least one of a beacon, synchronization signal, or reference signal and receive the paging occurrence.

2. The apparatus of claim 1, wherein the at least one of a beacon,
synchronization signal, or reference signal is received by the group or sub-group of user equipment with a low-power wake-up receiver.

3. The apparatus of claim 1, wherein the at least one of a beacon,
synchronization signal, or reference signal is addressed to the group or sub-group of user equipment, and wherein waking from sleep mode or powering on to decode the at least one of a beacon, synchronization signal, or reference signal is based on the user equipment being common to the group or sub-group of user equipment.

4. The apparatus of claim 1, wherein the at least one of a beacon,
synchronization signal, or reference signal comprises an m-sequence or Walsh code fitting with on-off keying and at least one frequency shift keying modulation.

5. The apparatus of claim 1, wherein the paging occurrence comprises a paging arrival for a common cause comprising one of an emergency page message or a system information change intended for the group or sub-group of user equipment, and
wherein waking from sleep mode or powering on to decode the at least one of a beacon, synchronization signal, or reference signal is based on the paging arrival for the common cause emergency page message or the system information change.

6. The apparatus of claim 5, wherein the at least one of a beacon,
synchronization signal, or reference signal comprises at least one predetermined binary sequence common to the group or sub-group of user equipment to cause reception of the common cause emergency page message or the system information change across the communication network or in a specific cell of the communication network.

7. The apparatus of claim 5, wherein the at least one of a beacon,
synchronization signal, or reference signal comprises content of the common cause emergency page message or the system information change.

8. The apparatus of claim 5, wherein the at least one of a beacon,
synchronization signal, or reference signal comprises a low power wake-up signal and the common cause emergency page message or the system information change.

9. The apparatus of claim 6, wherein the at least one predetermined binary sequence is using a high hamming distance to enable intended sequence detection.

10. The apparatus of claim 1, wherein the at least one non-transitory memory storing instructions is executed by the at least one processor to cause the apparatus to:
receive from the communication network a configuration with a dedicated time and frequency location to monitor for the at least one of a beacon, synchronization signal, or reference signal.

11. The apparatus of claim 10, wherein the configuration is received via at least one of system information blocks or dedicated signaling.

12. A method, comprising:
receiving, by a user equipment from a network node of a communication network, at least one of a beacon, synchronization signal, or reference signal comprising an indication of a paging occurrence,
wherein the at least one of a beacon, synchronization signal, or reference signal comprises a pseudo noise sequence as an indication of the paging occurrence,
wherein the at least one of a beacon, synchronization signal, or reference signal is addressed to all user equipment of a group or sub-group of user equipment in at least one cell of the communication network, and
wherein the at least one of a beacon, synchronization signal, or reference signal comprises a paging arrival for a common cause, and
wherein at least one user equipment of the group or sub-group of user equipment is in one of a sleep mode or powered off; and
based on the at least one of a beacon, synchronization signal, or reference signal, waking from the sleep mode or powering on to decode the at least one of a beacon, synchronization signal, or reference signal and receive the paging occurrence.

13. An apparatus, comprising:
at least one processor; and
at least one non-transitory memory storing instructions, that when executed by the at least one processor, cause the apparatus at least to:
determine, by a network node of a communication network, at least one of a beacon, synchronization signal, or reference signal comprising an indication of a paging occurrence,
wherein the at least one of a beacon, synchronization signal, or reference signal comprises a pseudo noise sequence as an indication of the paging occurrence,
wherein the at least one of a beacon, synchronization signal, or reference signal is addressed to all user equipment of a group or sub-group of user equipment in at least one cell of the communication network, and
wherein the at least one of a beacon, synchronization signal, or reference signal comprises a paging arrival for a common cause, and
based on the determining, send towards at least one user equipment of the group or sub-group of user equipment information comprising the at least one of a beacon, synchronization signal, or reference signal to cause the at least one user equipment to decode the at least one of a beacon, synchronization signal, or reference signal for reception of a paging occurrence.

14. The apparatus of claim 13, wherein the user equipment is in one of a sleep mode or powered off, and wherein the at least one of a beacon, synchronization signal, or reference signal causes user equipment to wake from a sleep mode or power on to decode the at least one of a beacon, synchronization signal, or reference signal and receive the paging occurrence.

15. The apparatus of claim 14, wherein the at least one of a beacon,
synchronization signal, or reference signal is addressed to a user equipment grouping, and wherein waking from sleep mode or powering on to decode the at least one of a beacon, synchronization signal, or reference signal is based on the at least one user equipment being common to the group or sub-group of user equipment.

16. The apparatus of claim 13, wherein the at least one of a beacon,
synchronization signal, or reference signal comprises a pseudo noise sequence as an indication of the paging occurrence.

17. The apparatus of claim 13, wherein the at least one of a beacon,
synchronization signal, or reference signal comprises an m-sequence or Walsh code fitting with on-off keying and at least one frequency shift keying modulation.

18. The apparatus of claim 14, wherein the paging occurrence comprises a paging arrival for a common cause comprising one of an emergency page message or a system information change intended for the group or sub-group of user equipment, and
wherein waking from sleep mode or powering on to decode the at least one of a beacon, synchronization signal, or reference signal is based on the paging arrival for the common cause emergency page message or the system information change.

19. The apparatus of claim 18, wherein the at least one of a beacon,
synchronization signal, or reference signal comprises at least one predetermined binary sequence common to user equipment to cause reception of the common cause emergency page message or the system information change across the communication network or in a specific cell of the communication network.

20-22. (canceled)

23. The apparatus of claim 13, wherein the at least one non-transitory memory storing instructions is executed by the at least one processor to cause the apparatus to:
send from the communication network towards the user equipment a configuration with a dedicated time and frequency location to monitor for the at least one of a beacon, synchronization signal, or reference signal.

24-25. (canceled)
